(19) United States
(12) Patent Application Publication
(10) Pub. No.: US 2015/0077759 A1
(43) Pub. Date: Mar. 19, 2015

(54) Compact, Slope Sensitive Optical Probe

(71) Applicants: Jonathan D. Ellis, Pittsford, NY (US); Christopher Roll, Arlington, MA (US); Andrew Keene, East Greenwich, RI (US); Michael A. Echter, Penfield, NY (US)

(72) Inventors: Jonathan D. Ellis, Pittsford, NY (US); Christopher Roll, Arlington, MA (US); Andrew Keene, East Greenwich, RI (US); Michael A. Echter, Penfield, NY (US)

(73) Assignee: UNIVERSITY OF ROCHESTER, Rochester, NY (US)

(21) Appl. No.: 14/446,790

(22) Filed: Jul. 30, 2014

Related U.S. Application Data
(60) Provisional application No. 61/859,944, filed on Jul. 30, 2013.

(51) Int. Cl. G01B 9/02; G01B 11/14; G01B 11/26; G01B 11/00

(52) U.S. Cl. CPC G01B 9/02015; G01B 11/005; G01B 9/02041; G01B 11/14; G01B 11/26
USPC 356/482; 356/477

(57) ABSTRACT

An optical probe system has a light source fiber-delivered and the detector fiber-coupled for analyzing carrier fringes using a line sensor to measure displacement and tilt. Simultaneous surface metrology to measure both the front and back surface of the same optic, is enabled provided the two surfaces are substantially parallel to within the measurement range. Alternatively, the front surface can be measured and then subsequently the back surface.

### CROSS REFERENCE

This application claims the benefit of the filing date of U.S. Provisional Patent Application Ser. No. 61/859,944, filed Jul. 30, 2013, which is hereby incorporated by reference in its entirety.

This invention was made with government support under Grant Nos. N68936-12-C-0092, N68936-12-00018 and N68936-12-00036 awarded by the United States Navy. The government has certain rights in this invention.

### FIELD

The present disclosure relates to an optical probe system, and in particular, an optical probe system that is slope sensitive.

### BACKGROUND

A sketch of the operating principle of a known optical probe is shown in FIG. 1. In essence, a light source (LED, laser diode, or fiber delivered laser) is split equally at a beamsplitter where one beam travels to the target/part, while the other beam reflects from a known, tilted reference surface. When the two beams recombine at the beamsplitter, a line sensor can be used to detect an interferogram that contains tilt fringes. The parallelism of the part/target and reference surface must be sufficient to have tilt fringes while not being too parallel so less than a fringe is imaged. Fringes shown on a line sensor can be analyzed in the Fourier Domain. The peak amplitude can be used to determine the nominal frequency of the tilt fringes and the phase can be determined from the Fourier analysis. When the part/target slope changes slightly, then the peak location of the amplitude in the Fourier domain shifts but the phase remains constant at the location of the peak amplitude in frequency. When the distance between the part/target changes, then the relative phase of the signal changes, which can be detected via Fourier analysis techniques. This can be modeled as well, showing that for resolution on the line sensor, high accuracy can be obtained.

Referring to the known optical system of FIG. 1, light from an optical source 2 is collimated using a lens 3 and sent to a beamsplitter 4. Part of the light is split at the beamsplitter 4 and the reflected part makes up the reference arm beam 13. The reference arm beam reflects from a reference surface 5 and then transmits through the beamsplitter 4 to make up part of the interference signal 15. The initially transmitted beam through the beamsplitter 4 is the measurement arm beam 14 and reflects from the measurement surface 6. The measurement surface's normal vector has a slight tilt with respect to the propagation direction of the measurement arm beam. The reflected beam from the measurement surface reflects at the beamsplitter 4 and makes up the other part of the interference signal 15. The interference signal 15 is imaged onto a detector 8 using imaging optics 7. The image detected by the detector 8 is sent to a processing unit 12 to determine signal attributes based on the recorded image. When the light source 2 has a long coherence length, the image detected 9 shows fringes over the full aperture. When the light source 2 has a short coherence length, the image detected 10 only shows fringes in part of the image based on the coherence length of the light source 2 and the relative positions between the measurement surface 5 and the reference surface 6. The optical path lengths between the measurement and reference arms in the interferometer must be matched to within the coherence length of the source for sufficient interference. When a single line of the images is analyzed 11, the measured signals have a series of fringes with amplitude and phase dependent on the light source 2 and optical path difference between the reference arm beam 13 and the measurement arm beam 14.

### SUMMARY

In accordance with one aspect illustrated herein, there is provided an optical probe system including a fiber collimator; an optical fiber capable of transmitting light from an optical source to the fiber collimator, the fiber collimator capable of splitting the transmitted light into first and second collimated light beams; and a beamsplitter capable of splitting the first collimated light beam into a reference arm beam and a measurement arm beam, wherein the reference arm beam includes light split from the first collimated light beam which is initially reflected from the beamsplitter to a reference surface and reflected from the reference surface back to the beamsplitter where part of the reference arm beam is transmitted, and wherein the measurement arm beam includes light split from the first collimated light beam which is initially transmitted through the beamsplitter to a sample surface, reflected from the sample surface to the beamsplitter then reflected by the beamsplitter where the reflected measurement arm beam interferes with the transmitted reference arm beam to form an interference signal, wherein an offset distance from the beamsplitter to the sample surface is such that the total optical paths of the measurement arm beam and reference arm beam are nominally equal and the interference signal is imaged into an optical fiber bundle and transmitted along an optical fiber where the nominal fringe pattern of the interference signal is retained.

In accordance with another aspect illustrated herein, there is provided a surface metrology system including a coordinate measuring machine having an optical probe system including a fiber collimator; an optical fiber capable of transmitting light from an optical source to the fiber collimator, the fiber collimator capable of splitting the transmitted light into first and second collimated light beams; and a beamsplitter capable of splitting the first collimated light beam into a reference arm beam and a measurement arm beam, wherein the reference arm beam includes light split from the first collimated light beam which is initially reflected from the beamsplitter to a reference surface and reflected from the reference surface back to the beamsplitter where part of the reference arm beam is transmitted, and wherein the measurement arm beam includes light split from the first collimated light beam which is initially transmitted through the beamsplitter to a sample surface, reflected from the sample surface to the beamsplitter then reflected by the beamsplitter where the reflected measurement arm beam interferes with the transmitted reference arm beam to form an interference signal, wherein an offset distance from the beamsplitter to the sample surface is such that the total optical paths of the measurement arm beam and reference arm beam are nominally equal and the interference signal is imaged into an optical fiber bundle and transmitted along an optical fiber where the nominal fringe pattern of the interference signal is retained; a detection system including a second beamsplitter where part of the light from the interference signal is reflected to an array detector which images the fiber interference signal resulting in a recorded array interference and part of the light from the interference signal is transmitted; and a third beamsplitter where part of the transmitted interference signal light from the second beamsplitter is reflected and imaged onto a first line sensor and part of the transmitted interference signal light from the second beamsplitter is transmitted and imaged onto a second line sensor, wherein the first line sensor records a line image from the fiber interference image and the second line sensor records an orthogonal line image from the fiber interference image where the orthogonality is with respect to the line image; and a processing unit capable of determining the frequency and phase of the images from the recorded array interference, line image, and orthogonal line image.

In accordance with another aspect illustrated herein, there is provided a dual surface metrology system including a coordinate measuring machine having an optical probe system including a fiber collimator; an optical fiber capable of transmitting light from an optical source to the fiber collimator, the fiber collimator capable of splitting the transmitted light into first and second collimated light beams; and a beamsplitter capable of splitting the first collimated light beam into a reference arm beam and a measurement arm beam, wherein the reference arm beam includes light split from the first collimated light beam which is initially reflected from the beamsplitter to a reference surface and reflected from the reference surface back to the beamsplitter where part of the reference arm beam is transmitted, and wherein the measurement arm beam includes light split from the first collimated light beam which is initially transmitted through the beamsplitter to a sample surface, reflected from the sample surface to the beamsplitter then reflected by the beamsplitter where the reflected measurement arm beam interferes with the transmitted reference arm beam to form an interference signal, wherein an offset distance from the beamsplitter to the sample surface is such that the total optical paths of the measurement arm beam and reference arm beam are nominally equal and the interference signal is imaged into an optical fiber bundle and transmitted along an optical fiber where the nominal fringe pattern of the interference signal is retained, wherein the optical source includes a first optical fiber transmitted light source and a second optical fiber transmitted light source, where one of the wavelengths of the first and second light sources is transparent to the sample and the first optical fiber and second optical fiber are combined prior to being sent to the fiber collimator through the optical fiber; and wherein the reference surface includes a dichroic mirror having a thickness and refractive index nominally equal to the sample thickness and refractive index, that reflects light with wavelengths nominally equal to the first optical fiber transmitted light source and transmits light with wavelengths nominally equal to the second optical fiber transmitted light source, such that a front surface interference beam and back surface interference beam are imaged into the optical fiber bundle; a detection system including a second fiber collimator capable of collimating the front surface interference beam and the back surface interference beam of the optical fiber bundle; a dichroic beamsplitter capable of reflecting the back surface interference beam and transmitting the front surface interference beam; a second beamsplitter which splits the front surface interference beam transmitted through the dichroic beamsplitter into a reflected beam and a transmitted beam, a first array detector which images the reflected beam from the second beamsplitter; a third beamsplitter which splits the transmitted beam from the second beamsplitter into a reflected beam and a transmitted beam; a front surface line sensor which images the reflected beam from the third beamsplitter; an orthogonal front surface line sensor which images the transmitted beam through the third beamsplitter, wherein the orthogonal front surface line sensor is orthogonal with respect to the front surface line sensor; a fourth beamsplitter which splits the back surface interference beam reflected from the dichroic beamsplitter into a reflected beam and a transmitted beam; a second array detector which images the transmitted beam from the fourth beamsplitter; a fifth beamsplitter which splits the reflected beam from the fourth beamsplitter into a reflected beam and a transmitted beam; a back surface line sensor which images the reflected beam from the fifth beamsplitter; and an orthogonal back surface line sensor which images the transmitted beam through the fifth beamsplitter, wherein the orthogonal back surface line sensor is orthogonal with respect to the back surface line sensor and the front surface line sensor is aligned parallel with the back surface line sensor; and a processing unit capable of determining the frequency and phase of the images from the recorded signals from the first array detector, second array detector, front surface line sensor, orthogonal front surface line sensor, back surface line sensor, and orthogonal back surface line sensor.

These and other aspects of the subject matter illustrated herein will become apparent upon a review of the following detailed description and the claims appended thereto.

### BRIEF DESCRIPTION OF THE DRAWINGS

FIG. 1 is a schematic of a prior art optical system for measuring displacement and tilt of a target;

FIG. 2 is a schematic of an embodiment illustrated herein of an optical system for measuring displacement and tilt of a target utilizing an optical fiber bundle;

FIG. 3 is a schematic of an embodiment illustrated herein of a detection system for use in the optical system of Figure;

FIG. 4 is a schematic of an embodiment illustrated herein of an optical system where the measurement arm beam is focused on to the back surface of the sample optic through the front surface of the sample optic;

FIG. 5 is a schematic of an embodiment illustrated herein of a dual surface optical probing system;

FIG. 6 is a schematic of an embodiment illustrated herein of a splitting and detection system for use in the optical system of FIG. 5;

FIG. 7 is a schematic of an embodiment illustrated herein of a dual surface metrology system;

FIG. 8 is the first image in a series of movie images that was taken directly from the camera of overall tilt fringes generated from Example 1;

FIG. 9 is the raw signal taken from the image of FIG. 8 using only a single horizontal line from the center;

FIG. 10 is the spatial Fourier domain magnitude signal showing the raw and processed generated in Example 1;

FIG. 11 is a graph showing the phase at the spatial frequency number generated in Example 1; and

FIG. 12 is a diagram of the angle relative to the reference surface.

### DETAILED DESCRIPTION

The present disclosure relates to an optical sensor system having the source fiber-delivered and the detector fiber-coupled for analyzing carrier fringes using a line sensor to measure displacement and tilt.

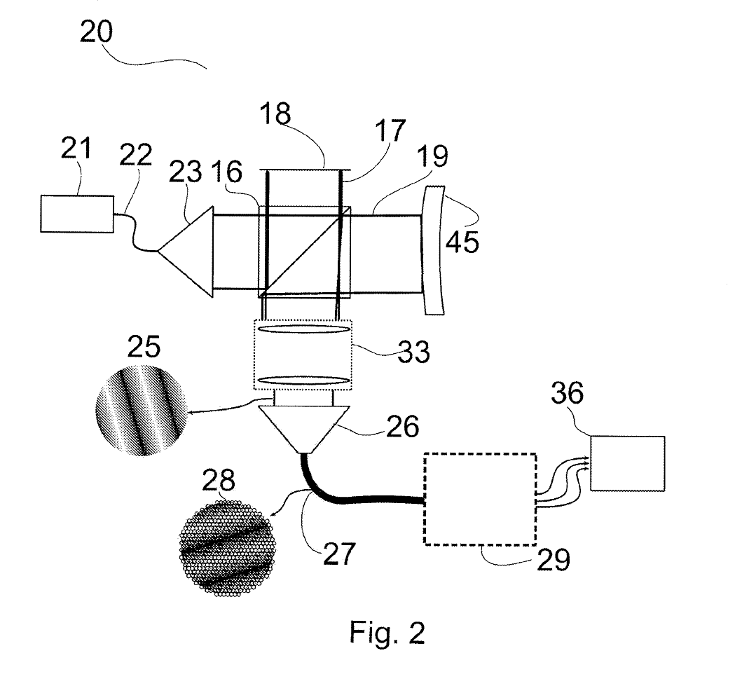

An example of an embodiment that achieves this is shown in FIG. 2. The sensor is composed of a fiber coupled light source that transmits light through an optical fiber to the interferometer. The interference signal is transmitted through an optical fiber bundle. The light from this optical fiber bundle is then collimated and split where it is imaged on several detectors. Preferably, one detector is a CMOS or CCD detector that gives an overall image of the interference fringes. Preferably, the other two detectors are high speed line sensors that are oriented orthogonally from each other. These line sensors are processed at high speeds to determine the displacement and angle from the phase and frequency, respectively.

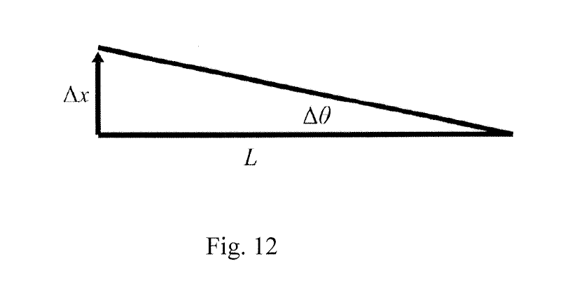

The signal from the line sensor (such as a truncated CMOS image) is a N-point array where N is the number of pixels across the sensor and spatial position is determined based on the period spacing between pixels. This can range from a few micrometers to 10's of micrometers depending on the sensor. The relative spacing of the fringes is known, provided the diameter of the fiber bundle is known. A Fourier analysis can be performed continuously on the tilt fringes to determine slight changes in spatial frequency and phase, which enables determining displacement and tilt of the target surface. When the number of fringes changes, the frequency of the primary peak in the Fourier doman shifts. The angle relative to the reference surface is related to the number of fringes by the following relationships:

$$\begin{matrix}Δ x = \frac{λ F}{2} - \frac{λ {F}_{i}}{2} & ( 1.1 ) \\ Δ θ = arctan ( \frac{Δ x}{L} ) & ( 1.2 )\end{matrix}$$

where F is the number of tip or tilt fringes in the current frame, F, is the initial number of fringes, λ is the nominal wavelength of the laser source, L is the width of the image in the fibers, and Δθ is the change in relative tip or tilt, as shown in FIG. 12. This assumes the light imaged on the line sensors fills the sensor completely. As the measurement surface is displaced, the phase at a fixed point in the frequency domain changes. The displacement is related to phase angle through

$$Δ d = \frac{θ λ}{4 π} - \frac{{θ}_{i} λ}{4 π} \qquad ( 1.3 )$$

where θ is the current phase angle, and θᵢ; is the initial phase angle. Because the phase changes between 0 and 2π, the data should be unwrapped before this calculation can be made correctly. This angle is in radians and therefore it is divided by 2π rad (as seen in Equation 1.3) to achieve units of length. The measured displacement should be the same when calculated from both orthogonal line samples.

The operating tilt range is governed by a simple principle that says at least one complete tilt fringe should be present across the fiber array because the analysis is Fourier-based. To maintain Nyquist sampling criteria, at least 2 points per fringe are used. Thus, based on the number of fibers in the fiber bundle and the line sensor pixel pitch, the tilt range of the sensor can be determined in accordance with methods known in the art. In practice and simulations, several fringes across the line sensor are used to more accurately employ Fourier analysis techniques. Signal processing techniques such as zero padding, windowing, and parabolic curve fitting can be used to enhance the displacement and angle resolution by helping interpolate in the Fourier Domain.

Referring to an embodiment of an optical probe system 20 of FIG. 2, light from a fiber coupled optical source 21 is transmitted along an optical fiber 22 that is typically single mode. The light from the optical fiber 22 is collimated with a fiber collimator 23 and sent to the beamsplitter 16. The initially reflected light from the beamsplitter is the reference arm beam 17 which reflects from a reference surface 18. The reflected light then travels back to the beamsplitter 16 where part of the reference arm beam is transmitted. The initially transmitted light from the beamsplitter 16 is the measurement arm beam 19. The measurement arm beam 19 reflects from the surface of the sample 45 where it is reflected by the beamsplitter and interferes with the reference arm beam 17. The offset distance from the beamsplitter 16 to the surface of the sample optic 45 is such that the total optical paths of the measurement arm beam 19 and reference arm beam 17 are nominally equal. The interference signal 25 is imaged into an optical fiber bundle 27 using imaging optics 33 and/or a coupling lens 26. The interference signal 25 is transmitted into the fiber bundle and transmitted along the fiber where it retains the same nominal fringe pattern 28 although it may rotate based on the orientation of the optical fiber bundle 27. The optical fiber bundle 27 is sent to a detection system 29 where the detected signals are processed in processing unit 36.

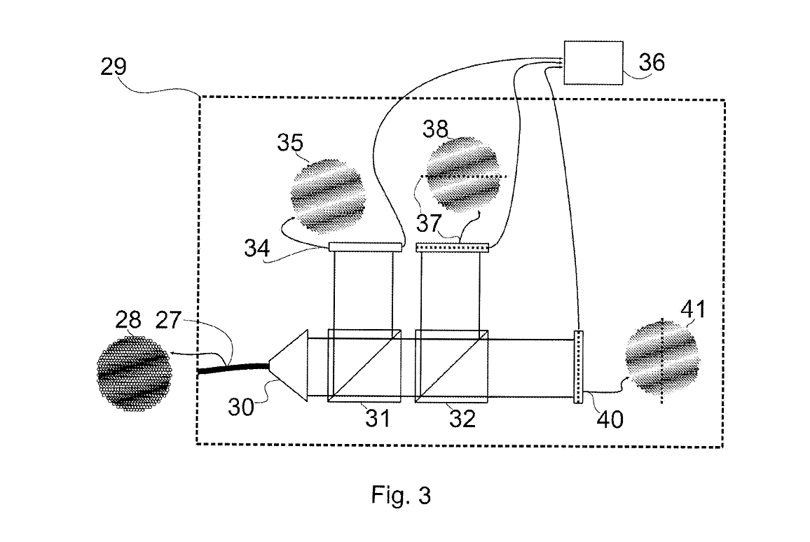

Referring to FIG. 3 is shown an embodiment of the detection system 29 of FIG. 2 where the fiber interference image 28 in the optical fiber bundle 27 is collimated using a fiber collimator 30. The collimated light is sent to a first beamsplitter 31 where part of the light is reflected to an array detector 34, such as a CCD or CMOS array. The array detector 34 images the fiber interference image 28 resulting in a recorded array interference 35. The initially transmitted beam from the first beamsplitter 31 is sent to a second beamsplitter 32 where part of the light is reflected and imaged on to a first line sensor 37 and part of the light is transmitted and imaged on to a second line sensor 40. The first line sensor records a line image 38 from the fiber interference image 28. The second line sensor records an orthogonal line image 41 from the fiber interference image 28 where the orthogonality is with respect to the line image 38. The recorded array interference 35, line image 38, and orthogonal line image 41 are sent to a processing unit 36 where the frequency and phase of the images can be determined using known techniques.

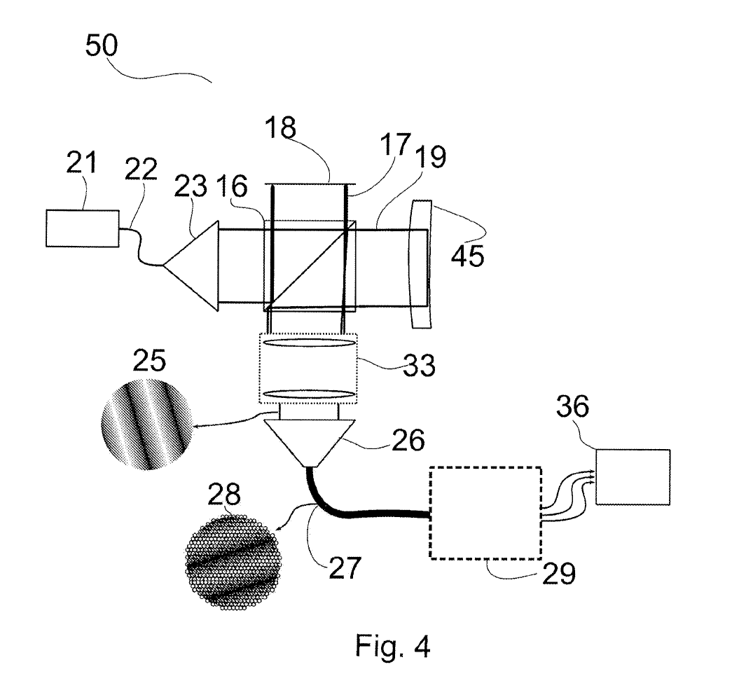

Referring to an embodiment of an optical probe system 50 of FIG. 4, the measurement arm beam 19 reflects from the back surface of the sample optic 45 through the front surface of the sample optic. The sample optic 45 should be at least partially transparent to the wavelength of light from the fiber coupled optical source 21. The offset distance from the beamsplitter 16 to the back surface of the sample optic 45 is such that the total optical paths of the measurement arm beam 19 and reference arm beam 17 are nominally equal. The light source 21 is chosen to be nominally transmissive given the material properties of the sample optic 45.

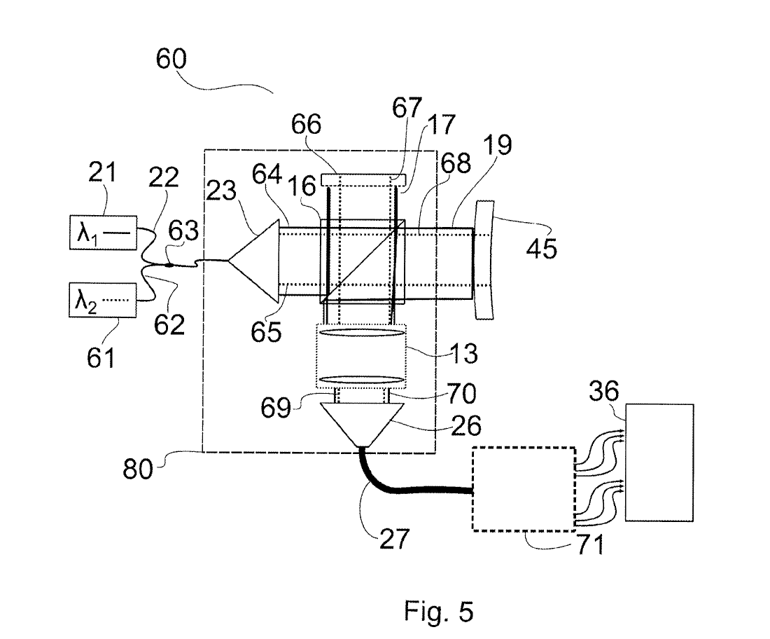

Referring to an embodiment of a dual surface optical probing system 60 of FIG. 5, included is a first fiber light source 21 and a second fiber light source 61 where one of the wavelengths of the sources is transparent to the sample optic 45. In FIG. 5, the second fiber light source 61 is depicted as the one transparent to the sample optic 45. The first fiber light source 21 is transmitted through a first optical fiber 22 and the second fiber light source 61 is also transmitted through a second optical fiber 62. The first optical fiber 22 and second optical fiber 62 are combined using a 2×1 coupler 63 prior to being sent to the fiber probing system 80. A fiber collimator 23 collimates the first optical beam 64 and the second optical beam 65 from the 2×1 coupler 63. The first optical beam 64 travels to a beamsplitter 16 where the first reference arm beam 17 reflects from the beamsplitter 16 and travels to a dichroic mirror 66 that reflects light with wavelengths nominally equal to the first fiber optical source 21 and transmits light with wavelengths nominally equal to the second fiber optical source 61. The first reference arm beam 17 reflects from the dichroic minor 66 and transmits through the beamsplitter 16. The initially transmitted first optical beam 64 from the beamsplitter 16 is the first measurement arm beam 19 that reflects from the front surface of the sample optic 45. The first measurement arm beam 19 reflects from the front surface and then is reflected at the beamsplitter 14 where it interferes with the first reference arm beam 17, creating the front surface interference beam 70.

The second optical beam 65 travels to a beamsplitter 16 where the second reference arm beam 67 reflects from the beamsplitter 16 and travels to a dichroic mirror 66 that reflects light with wavelengths nominally equal to the first fiber optical source 21 and transmits light with wavelengths nominally equal to the second fiber optical source 61. The second reference arm beam 67 reflects from the back of the dichroic mirror 66 whose thickness and refractive index is nominally equal to the sample optic 45 thickness and refractive index and transmits through the beamsplitter 16. The initially transmitted second optical beam 65 from the beamsplitter 16 is the second measurement arm beam 68 that reflects from the back surface of the sample optic 45. The second measurement arm beam 68 reflects from the back surface and then is reflected at the beamsplitter 16 where it interferes with the first reference arm beam 67, creating the back surface interference beam 69. The front surface interference beam 70 and back surface interference beam 69 are imaged into an optical fiber bundle 27 using at least one of imaging optics 13 and a fiber coupler 26. The fiber bundle is sent to the splitting-and-detection-system 71 where the detected signals are sent to a processing unit 36.

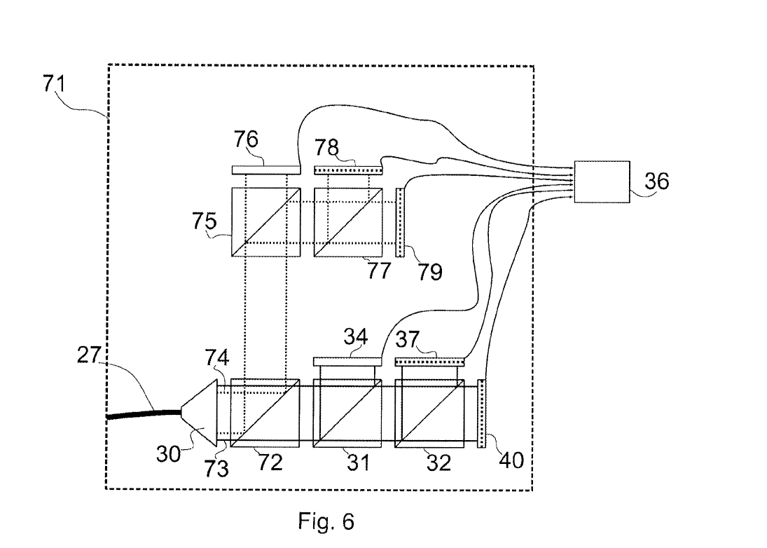

Referring to an embodiment of a splitting and detection system 71 of FIG. 6 where the optical fiber bundle 27 has the front surface detection beam 73 and the back surface detection beam 74 collimated using a fiber collimator 30. The front surface detection beam 73 and the back surface detection beam 74 are both sent to a dichroic beamsplitter 72 where the back surface detection beam 74 reflects and the front surface detection beam 73 transmits. The front surface detection beam 73 transmits through the dichroic beamsplitter 72 where the beam is split by a first beamsplitter 31. The reflected beam from the first beamsplitter is imaged on to a first array detector 34. The initially transmitted beam through the first beamsplitter 31 is sent to a second beamsplitter where the beam is split again. The reflected beam from the second beamsplitter is imaged on to a front surface line sensor 37 and the initially transmitted beam from the second beamsplitter is imaged on to an orthogonal front surface line sensor 40. The orthogonal front surface line sensor 40 is orthogonal with respect to the front surface line senor 37.

The back surface detection beam 74 reflects at the dichroic beamsplitter 72 where it is split by a third beamsplitter 75. The transmitted beam from the third beamsplitter 75 is imaged on to a second array detector 76. The initially reflected beam through the third beamsplitter 75 is sent to a fourth beamsplitter 77 where it is split again. The reflected beam from the fourth beamsplitter 77 is imaged on to a back surface line sensor 78 and the initially transmitted beam from the fourth beamsplitter 77 is imaged on to an orthogonal back surface line sensor 79. The orthogonal back surface line sensor 79 is orthogonal with respect to the back surface line senor 78. The front surface line sensor 37 is typically aligned to be parallel with the back surface line sensor 78.

Signals from the first array detector 34, second array detector 76, front surface line sensor 37, orthogonal front surface line sensor 40, back surface line sensor 78, and orthogonal back surface line sensor 79 are sent to a processing unit 36.

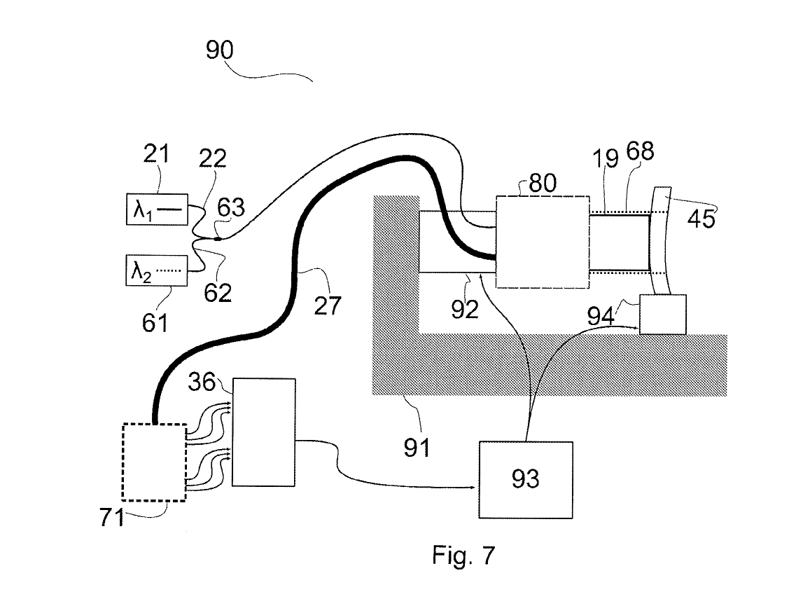

Referring to an embodiment of a dual surface metrology system 90 of FIG. 7, including the first fiber optical source 21, first optical fiber 22, second fiber optical source 61, second optical fiber 62, 2×1 fiber coupler 63, fiber probing system 80, optical fiber bundle 27, splitting and detection system 71, and processing unit 36. The fiber probing system 80 is mounted on computer controlled stages 92 which are mounted on a machine base 91. The sample optic 45 is mounted on sample computer controlled stages 94, which are mounted to the same machine base 91. The first measurement arm beam 19 and second measurement arm beam 68 are nominally focused on to the front surface and back surface, respectively, of the sample optic 45. The signals from the processing unit 12 are sent the machine controller 93 that controls the computer controlled stages 92 and sample computer controlled stages 94. Based on the signals processed and recorded in the processing unit 36, the positions of the computer controlled stages 92 and sample computer controlled stages 94 are adjusted to ensure the fiber probing system 80 is nominally normal to the sample optic 45 and the first measurement arm beam is in focus at the sample optic 45 front surface.

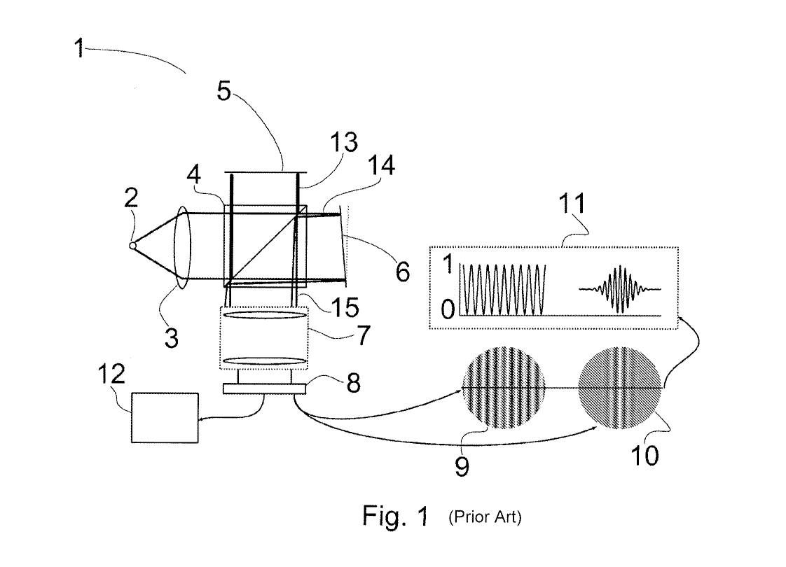

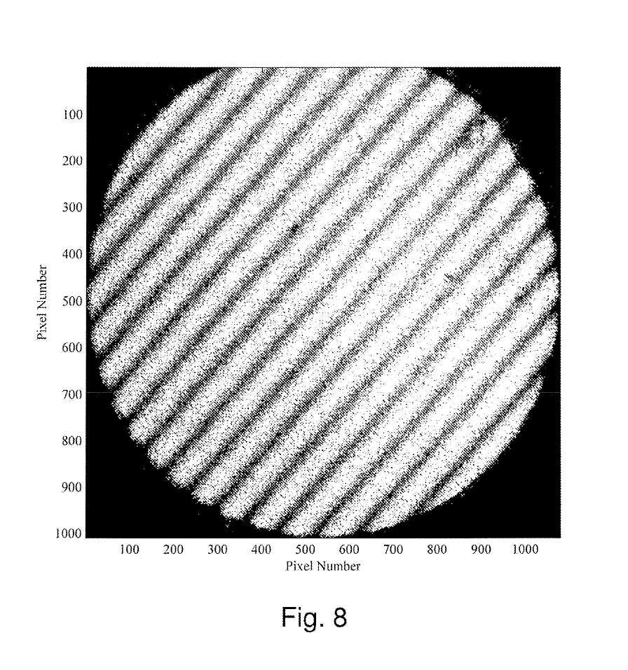

Example 1—The following example was conducted in accordance with the present invention. Quasi-monochromatic light with a wavelength of nominally about 646 nm from a fiber coupled laser source 21 was delivered via the fiber 22 to the optical probe system 20, as depicted in FIG. 1. An approximately 25 mm aspheric lens 23 was used to collimate the light into the beamsplitter 16. The light reflecting from the beamsplitter 16 was sent to the reference arm beam 17, which reflects from the stationary minor 18, whose position, tip, and tilt can be changed as desired. The light transmitting from the beamsplitter 16 is the measurement arm beam. The sample 45 used was a second mirror, also with position, tip, and tilt control. Further, the sample mirror (the sample analog) was on a stage that can be positioned remotely by sending an electrical signal to a piezoelectric device. Both beams 17, 19 reflect from their respective minors and interfere at the beamsplitter 16. The information depicted in FIGS. 8-11 was generated without using the imaging system 33 or coupling lens 26 shown in FIG. 1, as no magnification of the signal was needed. Rather, the interference signal 25 was directly transmitted through the fiber bundle 27. The detection system 29 was simplified from that shown in FIG. 3, to a fiber collimator 30 and another lens to image onto an area detector 34. The signal from the area detector 34 was sent to the processing unit 36, which was a computer in this case. A series of images were then acquired in a video form, which were then post-processed to select only a single line of pixels and determine the spatial frequency and phase, as shown in FIGS. 8-11.

FIG. 8 represents the first image in a series of images taken as a movie depicting the signal generating the tilt fringes from Example 1. The overall tilt fringes are apparent but there are other smaller features shown due to the fiber bundle. The outer edge of the fiber bundle is about 1.1 mm in diameter.

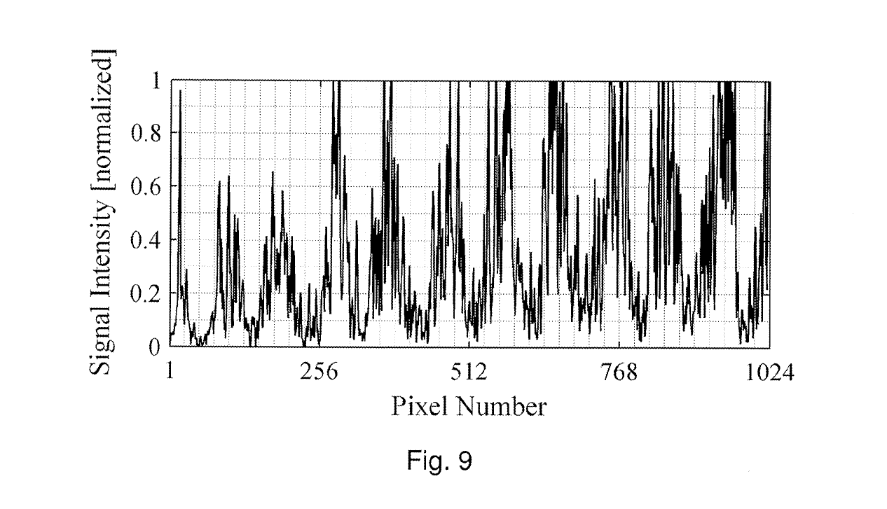

FIG. 9 is the raw signal taken from FIG. 8 using only a single horizontal line from the center. There are several overall transitions (signals of interest) superimposed on a bunch of noise due to the fiber bundle (which is removed for processing of the signals).

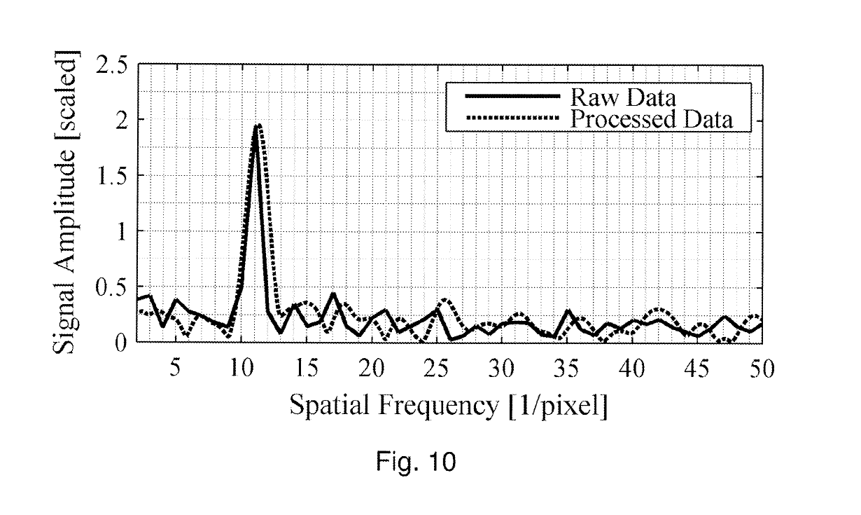

FIG. 10 is the spatial Fourier domain magnitude the signal generated by Example 1. The raw signal without any processing and the processed signal are shown using standard techniques. The y-axis is scaled but this does not affect the measurement. The raw data is more jagged and has a peak somewhere around 12, but it is not well defined. The processed data, however, has been smoothed and upsampled. While not readily apparent from the figure, the processed data is very smooth around the peak and has many more points to help define the actual peak. The peak detection algorithm further interpolates this data to establish a well defined spatial frequency number. The location in the spatial frequency determines the angle of the mirror.

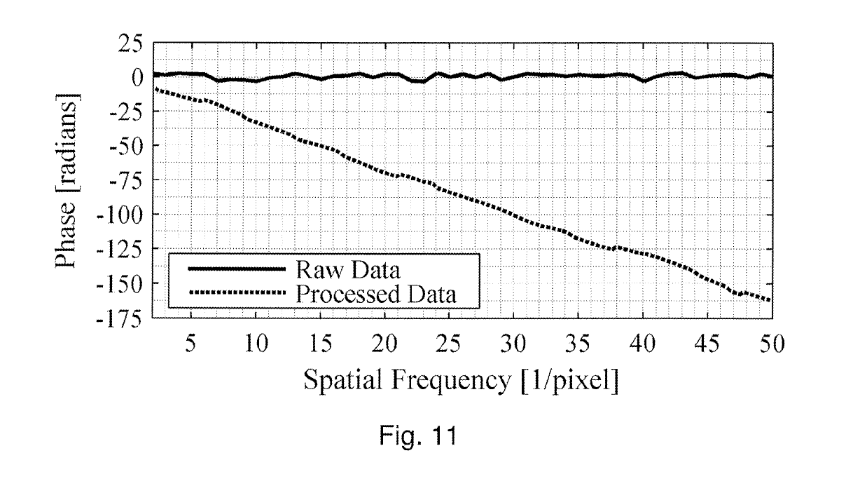

FIG. 11 is a graph from Example 1, showing that once the spatial frequency number is determined, the phase at that spatial frequency point is taken. This is a plot of the unprocessed raw data and the processed data after interpolation, filtering, and unwrapping. The point corresponding to the spatial frequency from the previous FIG. 10 is the point of interest.

In addition to using a long coherence source, suitable sources further include a white light source to have a short window where the optical path length between the reference minor and measurement mirror produce interference fringes. This has the added benefit of measuring the absolute distance, rather than just the relative distance. When this method is employed, the absolute distance between the optical probe and the target is determined by the peak location of the correlogram. As the absolute distance between the optical probe and the target changes, the peak location of the correlogram shifts, which location can be detected and used for feedback control. This feedback control can be used to ensure that the optical probe maintains a constant distance from the target.

The present invention has advantages over exiting optical probing technologies because it can inherently sense two degrees of freedom and is readily adaptable for three degree of freedom sensing. These added degrees of freedom means the probe can be aligned with a known surface normality, improving the accuracy of the measurement over other optical probes.

The present technology has advantages over existing technologies, such as capacitive sensors, because the present technology has a similar cost and the potential for 100× greater displacement ranges to be measured. Also, the target can be much smaller than typical capacitive sensors. The present technology has advantages over eddy current/inductive sensors because it can get a much higher resolution and is not influenced by stray magnetic fields. Additionally, it has better drift than eddy current/inductive sensors. It is better than linescales because it can work on-axis rather than perpendicular to the axis and the standoff distance is much greater. Also, a glass scale is not needed. It is better than displacement interferometers because the potential production cost is significantly less (−20×) and it can be fiber-fed. It is better than other optical sensors because it does not require an expensive laser source or a known scan of the laser source, which is a significant cost driver for these sensors. The present technology enables the light source to be fiber delivered and the signals generated to be fiber detected. This enables systems to be lighter in weight, more compact, and not heat sensitive as compared with existing systems. Additionally, the ability to fiber detect the signals allows the signals to be split into several different channels which can then be used for different types of sensing.

One novel and distinct feature of the present technology is that it can measure displacement and tilt of an object, thus it is inherently a 2-axis sensor. Additionally, there is the potential to modify the sensor to measure three axes (displacement, tip, and tilt). It can be adapted for silicon based devices, further shrinking the overall size, enhancing the scalability, enabling mass production, and has the potential to open up applications in biomedical fields.

The present technology solves a significant problem of sensor range, resolution, and bandwidth while limiting the overall cost. Typically, most sensors can achieve only two specifications but not the third. If a sensor can achieve all three, then the cost of the sensor is generally very high. Thus, it makes it impractical to use except in specific circumstances where those specifications impact the overall functioning system. For other optical sensors that may have this range, the bandwidth is typically too slow and then resolution is insufficient for many applications. This is because those sensors are built on technologies that require complex sources that scan in wavelength, frequency, or phase. However, the present sensor uses a passive architecture, which means it needs fewer components and can be made relatively cheaply while maintaining nanometer resolution with 10's of millimeters of range. Currently, there are no prior sensors which meet this capability.

The present technology has application in measuring optical surfaces, specifically freeform optical surfaces when used in conjunction with a coordinate measuring machine, such as a 5 axis coordinate measuring machine. The combination of measurements with the present technology and a coordinate measuring machine allows for measuring surfaces where the shape is only nominally known. When the present technology is aligned and accurately measuring position and orientation relative to the surface, the system is then repositioned using the coordinate measuring machine while using the measurement signals to ensure the relative position and orientation is maintained at a constant level. The coordinate measuring machine's trajectory is then used to determine the surface's topography.

One novel feature of the technology when used in this configuration is the ability to measure both the front and back surface of the same optic, provided the two surfaces are parallel to within the measurement range of the invention. This enables simultaneous surface metrology, which reduces the measurement time. Alternatively, the front surface can be measured and then subsequently the back surface.

It will be appreciated that variants of the above-disclosed and other features and functions, or alternatives thereof, may be combined into many other different systems or applications. Various presently unforeseen or unanticipated alternatives, modifications, variations, or improvements therein may be subsequently made by those skilled in the art which are also intended to be encompassed by the following claims.

What is claimed:

1. An optical probe system comprising:
a fiber collimator;
an optical fiber capable of transmitting light from an optical source to the fiber collimator, the fiber collimator capable of splitting the transmitted light into first and second collimated light beams; and
a beamsplitter capable of splitting the first collimated light beam into a reference arm beam and a measurement arm beam, wherein the reference arm beam comprises light split from the first collimated light beam which is initially reflected from the beamsplitter to a reference surface and reflected from the reference surface back to the beamsplitter where part of the reference arm beam is transmitted, and wherein the measurement arm beam comprises light split from the first collimated light beam which is initially transmitted through the beamsplitter to a sample surface, reflected from the sample surface to the beamsplitter then reflected by the beamsplitter where the reflected measurement arm beam interferes with the transmitted reference arm beam to form an interference signal,
wherein an offset distance from the beamsplitter to the sample surface is such that the total optical paths of the measurement arm beam and reference arm beam are nominally equal and the interference signal is imaged into an optical fiber bundle and transmitted along an optical fiber where the nominal fringe pattern of the interference signal is retained.

2. The optical probe system of claim 1, further comprising a detection system comprising:
a second beamsplitter where part of the light from the interference signal is reflected to an array detector which images the fiber interference signal resulting in a recorded array interference and part of the light from the interference signal is transmitted; and
a third beamsplitter where part of the transmitted interference signal light from the second beamsplitter is reflected and imaged onto a first line sensor and part of the transmitted interference signal light from the second beamsplitter is transmitted and imaged onto a second line sensor, wherein the first line sensor records a line image from the fiber interference image and the second line sensor records an orthogonal line image from the fiber interference image where the orthogonality is with respect to the line image.

3. The optical probe system of claim 2, further comprising a processing unit capable of determining the frequency and phase of the images from the recorded array interference, line image, and orthogonal line image.

4. The optical probe system of claim 1, wherein the optical source comprises a first optical fiber transmitted light source and a second optical fiber transmitted light source, where one of the wavelengths of the first and second light sources is transparent to the sample and the first optical fiber and second optical fiber are combined prior to being sent to the fiber collimator through the optical fiber; and wherein the reference surface comprises a dichroic mirror having a thickness and refractive index nominally equal to the sample thickness and refractive index, that reflects light with wavelengths nominally equal to the first optical fiber transmitted light source and transmits light with wavelengths nominally equal to the second optical fiber transmitted light source, such that a front surface interference beam and back surface interference beam are imaged into the optical fiber bundle.

5. The optical probe system of claim 4, further comprising a detection system comprising:
a second fiber collimator capable of collimating the front surface interference beam and the back surface interference beam of the optical fiber bundle;
a dichroic beamsplitter capable of reflecting the back surface interference beam and transmitting the front surface interference beam;
a second beamsplitter which splits the front surface interference beam transmitted through the dichroic beamsplitter into a reflected beam and a transmitted beam,
a first array detector which images the reflected beam from the second beamsplitter;
a third beamsplitter which splits the transmitted beam from the second beamsplitter into a reflected beam and a transmitted beam;
a front surface line sensor which images the reflected beam from the third beamsplitter;
an orthogonal front surface line sensor which images the transmitted beam through the third beamsplitter, wherein the orthogonal front surface line sensor is orthogonal with respect to the front surface line sensor;
a fourth beamsplitter which splits the back surface interference beam reflected from the dichroic beamsplitter into a reflected beam and a transmitted beam;
a second array detector which images the transmitted beam from the fourth beamsplitter;
a fifth beamsplitter which splits the reflected beam from the fourth beamsplitter into a reflected beam and a transmitted beam;
a back surface line sensor which images the reflected beam from the fifth beamsplitter; and
an orthogonal back surface line sensor which images the transmitted beam through the fifth beamsplitter, wherein the orthogonal back surface line sensor is orthogonal with respect to the back surface line sensor and the front surface line sensor is aligned parallel with the back surface line sensor.

6. The optical probe system of claim 5, further comprising a processing unit capable of determining the frequency and phase of the images from the recorded signals from the first array detector, second array detector, front surface line sensor, orthogonal front surface line sensor, back surface line sensor, and orthogonal back surface line sensor.

7. A surface metrology system comprising:
a coordinate measuring machine comprising:
an optical probe system according to claim 1,
a detection system comprising:
a second beamsplitter where part of the light from the interference signal is reflected to an array detector which images the fiber interference signal resulting in a recorded array interference and part of the light from the interference signal is transmitted; and
a third beamsplitter where part of the transmitted interference signal light from the second beamsplitter is reflected and imaged onto a first line sensor and part of the transmitted interference signal light from the second beamsplitter is transmitted and imaged onto a second line sensor, wherein the first line sensor records a line image from the fiber interference image and the second line sensor records an orthogonal line image from the fiber interference image where the orthogonality is with respect to the line image; and
a processing unit capable of determining the frequency and phase of the images from the recorded array interference, line image, and orthogonal line image.

8. A dual surface metrology system comprising:
a coordinate measuring machine comprising:
an optical probe system according to claim 1, wherein the optical source comprises a first optical fiber transmitted light source and a second optical fiber transmitted light source, where one of the wavelengths of the first and second light sources is transparent to the sample and the first optical fiber and second optical fiber are combined prior to being sent to the fiber collimator through the optical fiber; and wherein the reference surface comprises a dichroic mirror having a thickness and refractive index nominally equal to the sample thickness and refractive index, that reflects light with wavelengths nominally equal to the first optical fiber transmitted light source and transmits light with wavelengths nominally equal to the second optical fiber transmitted light source, such that a front surface interference beam and back surface interference beam are imaged into the optical fiber bundle;
a detection system comprising:
a second fiber collimator capable of collimating the front surface interference beam and the back surface interference beam of the optical fiber bundle;
a dichroic beamsplitter capable of reflecting the back surface interference beam and transmitting the front surface interference beam;
a second beamsplitter which splits the front surface interference beam transmitted through the dichroic beamsplitter into a reflected beam and a transmitted beam,
a first array detector which images the reflected beam from the second beamsplitter;
a third beamsplitter which splits the transmitted beam from the second beamsplitter into a reflected beam and a transmitted beam;
a front surface line sensor which images the reflected beam from the third beamsplitter;
an orthogonal front surface line sensor which images the transmitted beam through the third beamsplitter, wherein the orthogonal front surface line sensor is orthogonal with respect to the front surface line sensor;
a fourth beamsplitter which splits the back surface interference beam reflected from the dichroic beamsplitter into a reflected beam and a transmitted beam;
a second array detector which images the transmitted beam from the fourth beamsplitter;
a fifth beamsplitter which splits the reflected beam from the fourth beamsplitter into a reflected beam and a transmitted beam;
a back surface line sensor which images the reflected beam from the fifth beamsplitter; and
an orthogonal back surface line sensor which images the transmitted beam through the fifth beamsplitter, wherein the orthogonal back surface line sensor is orthogonal with respect to the back surface line sensor and the front surface line sensor is aligned parallel with the back surface line sensor; and
a processing unit capable of determining the frequency and phase of the images from the recorded signals from the first array detector, second array detector, front surface line sensor, orthogonal front surface line sensor, back surface line sensor, and orthogonal back surface line sensor.
